(19) United States
(12) Patent Application Publication
(10) Pub. No.: US 2016/0157675 A1
(43) Pub. Date: Jun. 9, 2016

(54) DUAL PURPOSE FRYER

(71) Applicant: PPM Technologies, LLC, Newberg, OR (US)

(72) Inventors: Zeljko Gvozdanovic, Katy, TX (US); Devin Ray Reeser, Portland, OR (US); Sergey Valeriy Sadovikov, Tigard, OR (US)

(21) Appl. No.: 14/961,719

(22) Filed: Dec. 7, 2015

Related U.S. Application Data
(60) Provisional application No. 62/089,150, filed on Dec. 8, 2014.

(51) Int. Cl. A47J 37/12

(52) U.S. Cl. CPC A47J 37/1233; A47J 37/1266; A23L 1/0107; A23L 1/217; A47J 37/1214; A23V 2002/00

(57) ABSTRACT

A dual purpose fryer for continuous preparation of fried products is disclosed. The dual purpose fryer may include an elongated cooking trough configured to hold a volume of cooking oil and including a plurality of fluid connected cooking zones. The temperature of the cooking oil within each cooking zone is established by controlling a flow rate of hot cooking oil into the cooking zone through a hot oil fryer inlet and a flow rate of cool cooking oil from the cooking zones through a cool oil fryer outlet. The temperature of the cooking oil within each of the cooking zones collectively establishes a thermal profile across the elongated cooking trough.

### CROSS REFERENCE TO RELATED APPLICATIONS

The present application claims priority to U.S. Provisional Patent Application No. 62/089,150 entitled “DUAL PURPOSE FRYER,” filed on Dec. 8, 2014, the entire contents of which are hereby incorporated by reference for all purposes.

### BACKGROUND/SUMMARY

Currently, the snack food market is awash with fried snack food products such as potato chips. The available potato chips vary in flavor, thickness, and texture. A number of methods are available to produce different types of potato chips. Generally, potato chips are prepared by slicing the raw potato to a desired thickness and frying the sliced potato in oil within a product fryer. The cook process, thickness of the potato slice, the thermal profile of the cooking oil within the fryer, and cook time produce the recognizable qualities of the final cooked product. The final cooked product may vary in thickness, crunch, shape, oil content and color. Example types of potato chips include standard continuous fryer chips (also referred to herein as a typical or standard potato chip) and kettle chips.

Typical potato chips are commonly cooked in a continuous fryer. The continuous fryer often includes an infeed for providing uncooked potato slices to the continuous fryer, an elongated trough containing a volume of cooking oil, an assembly to move the potato slices through the elongated trough during cooking, one or more cooking oil inlets to provide heated cooking oil to the elongated trough, and one or more cool oil outlets to remove cooled cooking oil from the trough. These features of the continuous fryer may be configured to provide a continuous cook process thermal profile.

The qualities of a typical potato chip (a light golden color, slight crunch, and low oil content) are all produced by the preparation of the raw potato slices and the thermal profile used to cook the raw chips. The common method employed to fry typical potato chips includes slicing the raw potato into thin slices and frying the thin slices in a continuous cook process. In this cook process, small amounts of potato slices may be added to the fryer in a continuous manner at one end of the elongated trough and cooked potato chips may be continuously removed from the opposite end of the trough. The continuous addition of small amounts of potato slices allows the fryer to rapidly reheat the cooking oil to recover heat transferred from the cooking oil to potato slices, which may be observed as a drop in temperature of the cooking oil, during the cooking process. This heat transfer to the potato slices and rapid return of the cooking oil temperature to the desired temperature will continuously occur longitudinally across the elongated trough as the potato slices move through the fryer until the cooking process is complete. The temperature of the cooking oil may be maintained through the rapid removal of cooled cooking oil and the subsequent addition of hot cooking oil. This rapid exchange of hot cooking oil for cooled cooking oil provides a relatively high ratio of heated cooking oil to mass of potato slices within any given region of the elongated trough during cooking. Additionally, the potato slices are moved rapidly through the fryer by the motive apparatus. A typical potato chip may be fully cooked in as short a time as 4 minutes. The factors described above produce the saw-tooth thermal profile characteristic of the continuous cook process illustrated in FIG. 9A. Furthermore, the properties of the continuous fryer allow for continuous and rapid production of cooked typical potato chips.

By comparison, a kettle chip is typically prepared in a kettle or batch fryer providing an inverse bell curve batch cook thermal profile illustrated in FIG. 9B. To obtain the batch cook thermal profile of the cooking oil required to obtain the distinct darker color and crunch of a kettle chip, the potato slices are cut thicker than typical potato chips and added in comparatively larger batches to the batch fryer. Upon addition of a batch of raw potato slices, the temperature of the cooking oil will decrease as the oil transfers heat to the potato slices. The magnitude of the temperature decrease of the oil is a function of the mass of the potato slices added and the temperature difference between the cooking oil and the potato. The lower oil temperature and cook time parameters may allow more oil to be absorbed into the potato slices. The absorbed oil may cook the potato slices from the inside of the potato slices. Over time, as the potato slices cook, the temperature difference between the cooking oil and the potato slices decreases. Concurrently, heat is added to the cooking oil by a heating element of the fryer system. This results in the temperature of the cooking oil increasing over time until the desired oil temperature is restored. Upon completion of the cooking time, the cooked kettle chips may be removed from the batch fryer. The longer cooking time of a kettle chip, typically 9-10 minutes, and the batch addition of potato slices in the batch cooking process may produce fewer potato chips over time than a comparable continuous fryer cooking typical potato chips. The final cooked chip will have a darker color, higher oil content, and more crunch than a typical potato chip.

The differing conditions of the batch cook process and the continuous cook process require specific equipment or dedicated fryers configured to provide the oil temperature and oil thermal profile to properly prepare the desired product. The additional equipment required to perform both the batch cook and the continuous cook processes may add additional equipment and maintenance expense.

The inventors herein have recognized the above described deficiencies of commonly prepared kettle chips and disclose a dual purpose fryer configurable for a continuous preparation of kettle chips. Further, the dual purpose fryer may be configured as continuous fryer for the continuous preparation of typical potato chips.

### BRIEF DESCRIPTION OF THE DRAWINGS

FIG. 1 illustrates a perspective view of dual purpose fryer in accordance with an embodiment of the present disclosure.

FIG. 2 illustrates a perspective view of a dual purpose fryer of FIG. 1 with the steam hood raised in accordance with an embodiment of the present disclosure.

FIG. 3 illustrates a second perspective view of the dual purpose fryer of FIG. 1.

FIG. 4 illustrates an exploded side view of the dual purpose fryer of FIG. 1.

FIG. 5 illustrates a side view of the dual purpose fryer of FIG. 1.

FIG. 6 illustrates a bottom view of the dual purpose fryer of FIG. 1.

FIG. 7 illustrates a top view of the elongated cooking trough of the dual purpose fryer of FIG. 1.

FIG. 8 schematically illustrates a system for controlling the temperature of cooking oil for the dual purpose fryer in accordance with an embodiment of the present disclosure.

FIGS. 9A and 9B illustrate respective cooking oil thermal profiles for a continuous cook process and a batch cook process.

### DETAILED DESCRIPTION

The embodiments provided herein disclose a dual purpose fryer configured to enable different thermal profiles for production of a selected type of potato chip. One particular embodiment of the dual purpose fryer of the present disclosure includes an elongated cooking trough continuous fryer configured to provide an inverse bell curve thermal profile of the cooking oil characteristic of a batch cook process. This embodiment of the dual purpose fryer enables a continuous “kettle-like” cook process for production of kettle chips. Another embodiment of the dual purpose fryer of the present disclosure includes a same elongated trough continuous fryer configured to provide a saw tooth shaped thermal profile of the cooking oil enabling a continuous cook process for production of typical or standard potato chips.

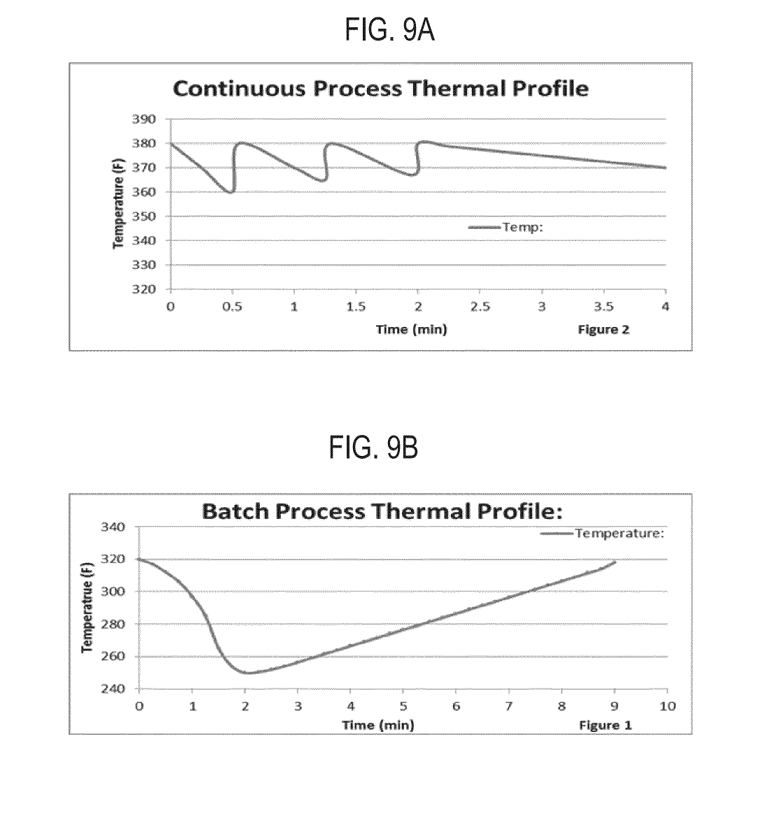

As discussed in detail below, the dual purpose fryer provides optional frying configurations, including a first continuous kettle-like cook process configuration using a batch process thermal profile shown in FIG. 9B and a second different continuous cook process configuration using a continuous process thermal profile shown in FIG. 9A for production of a different product. The thermal profile of the cooking oil within the dual purpose fryer may be established through control of the temperature of the cooking oil, control of the cook time of the product within specific regions of the dual purpose fryer, and control of the amount of product within the specific regions of the dual purpose fryer.

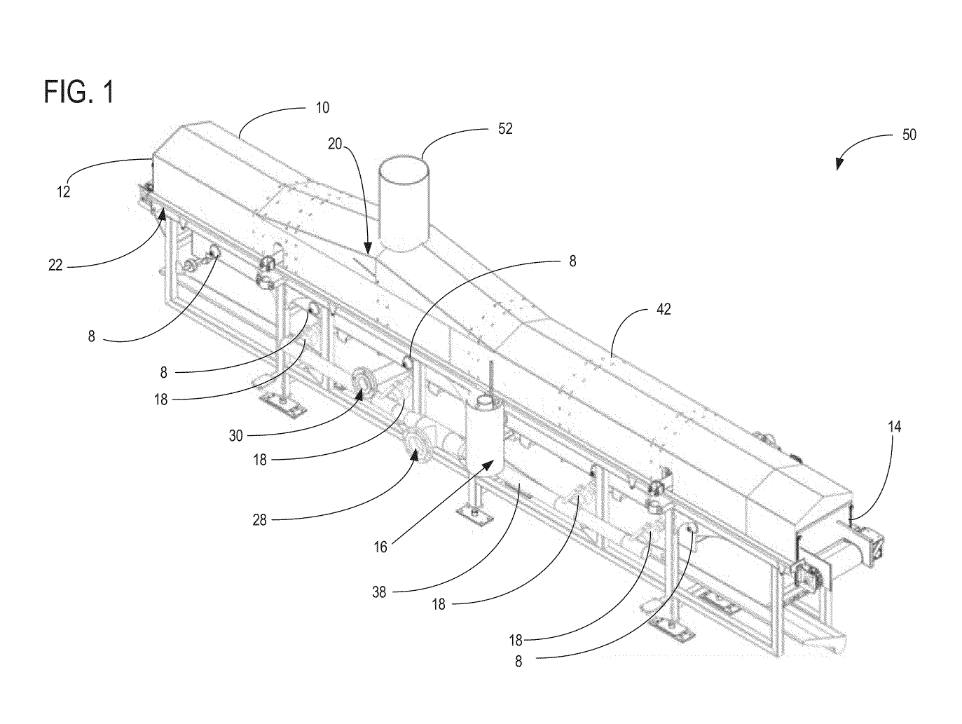

The disclosed dual purpose fryer illustrated in FIGS. 1-9 provides for establishing and controlling the thermal profile through mechanisms monitoring and controlling temperature of the cooking oil within the dual purpose fryer and controlling the cook time of the product by controlling the rate at which products move through the cooking oil. Additionally, the disclosed dual purpose fryer allows the frying configuration to be changed to any desired frying configuration and associated thermal profile.

FIG. 1 provides an example of the dual purpose fryer including indicators for thermal sensors where the thermal sensors provide controls for ensuring the select thermal profile is applied. The thermal sensors may indicate a temperature of the cooking oil within a specific area or cooking zone of dual purpose fryer. The thermal sensors may provide local or remote temperature data for an associated region or cooking zone within the dual purpose fryer.

The disclosed dual purpose fryer may include an elongated cooking trough configured to hold a volume of cooking oil and a plurality of cooking zones. For the purpose of discussion, the dual purpose fryer described below may include a number of cooking zones, such as the five example cooking zones illustrated herein. The cooking zones may be defined along the elongated cooking trough. Although discussed in regards to five cooking zones, any number of cooking zones may be used. For example, in some embodiments, two, three, four, five, six or more cooking zones may be utilized.

In some examples, the dual purpose fryer may not include a physical barrier between cooking zones. A cooking zone may be defined as a region of the elongated trough of the dual purpose fryer including one or more of a hot oil inlet, a cool oil outlet, and a thermal probe. In some examples, a thermal probe may be shared between cooking zones. Similarly the inlets and outlets may be shared between the cooking zones. The location and orientation of the hot oil inlets, cool oil outlet, and thermal probes will be discussed in further detail below.

The dual purpose fryer may provide for control of the temperature of the cooking oil within each cooking zone through control of the rate of addition of hot oil to each cooking zone and the rate of removal of cooler oil from each cooking zone. The dual purpose fryer may be connected to any suitable cooking oil heating system including, but not limited, to a fluid heat exchanger, direct electric heater, or direct gas heater. The cooking oil heating system may be connected to the dual purpose fryer such that the cooking oil heating system receives cool oil removed from the trough which may then be heated and returned to the dual purpose fryer via a hot oil inlet connection. The cool oil outlet removal system and hot oil inlet system will be discussed in detail below.

An additional parameter in the establishment of a desired thermal profile is the amount of time a product remains in a respective cooking zone. The disclosed dual purpose fryer provides a configurable conveyor system to convey the product through each cooking zone within the dual purpose fryer. The configurable conveyor system may provide specific characteristics or attachments required for a desired cook process. Further, the conveyor may be interchangeable to enable specific cooking processes. Additionally, the configurable conveyor may provide control of the rate and direction of conveyance of the products through the elongated cooking trough of the dual purpose fryer. Through control of the rate of the conveyor, the cook time of the products within specific cooking zones may be controlled in a manner to maintain the desired thermal profile within each cooking zone as the products cook and insure the product is properly cooked.

FIG. 1 illustrates a dual purpose fryer 50 in accordance with an embodiment of the present disclosure. Dual purpose fryer 50 may include a steam hood 10 for the collection and exhaust of steam released during the cooking process. The steam hood may exhaust the steam from the cooking process through a steam stack 52. Additionally, steam hood 10 may include a condensate collection tray 20 configured to collection water from condensed steam (condensate) and prevent the introduction of the water to the cooking oil. The collected condensate may be removed from the condensate collection plate by any suitable means. Steam hood 10 may be further configured with one or more condensate collection troughs 22. The steam hood 10 may also include an adjustable inlet door 12 enabling the addition of uncooked product to dual purpose fryer 50 and an adjustable outlet door 14 enabling the removal of cooked product from dual purpose fryer 50. Steam hood 10 may be secured in place over the elongated cooking trough by one or more top hold down belts 42.

Dual purpose fryer 50 may include a plurality of cool oil outlet flow control valves 18. Each cool oil outlet flow control valve 18 may be manipulated to control a flow rate of cool cooking oil removed from a specific region of dual purpose fryer 50. The cool oil may flow through cool oil outlet flow control valve 18 to a common cool oil outlet pipe 38. Cool oil outlet pipe 38 may include a cool oil outlet connection 28 to a cooking oil heating system (not shown). Heated cooking oil may be returned to the dual purpose fryer through hot oil inlet connection 30.

The dual purpose fryer 50 may include a plurality of thermal sensors 8 where each of the thermal sensors 8 monitors the temperature of cooking oil within a specific region of the dual purpose fryer 50. Thermal sensors 8 may include direct thermometers, thermocouples, or any other suitable temperature sensors. Cooking oil level within dual purpose fryer 50 may be sensed by cooking oil level sensor 16. Thermal sensors 8 and cooking oil level sensor 16 may provide signals indicating the cooking oil temperature and cooking oil level within dual purpose fryer 50 locally, remotely, to control system for dual purpose fryer 50, or any combination thereof.

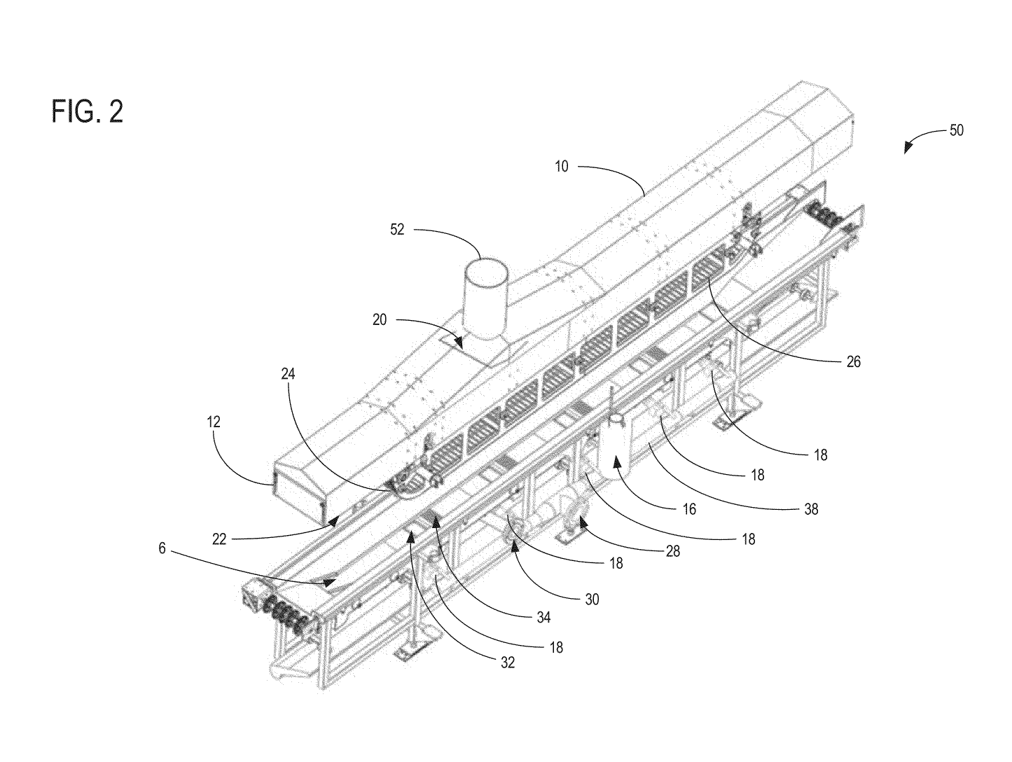

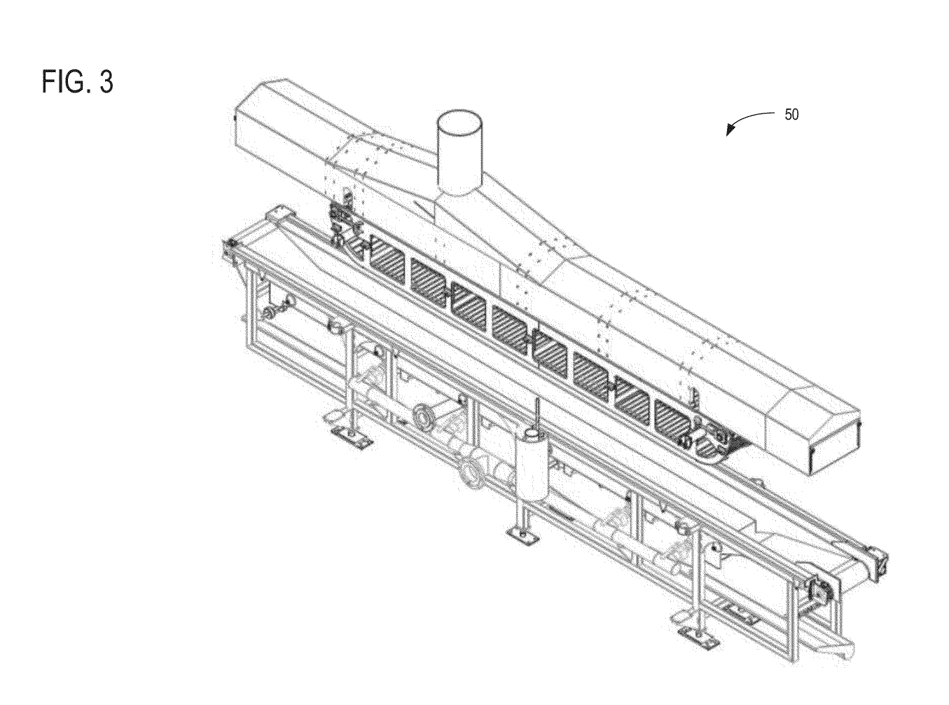

FIGS. 2 and 3 illustrate a perspective view of dual purpose fryer 50 with steam hood 10 elevated. A representative dual purpose fryer 50 will now be described with reference to FIG. 2. Dual purpose fryer 50 is shown including the steam hood 10 elevated over an elongated cooking trough 6. The elongated cooking trough is illustrated as an elongated trough structure mounted on an underlying frame. The trough has a flat bottom or bed and upstanding sidewalls that extend upwardly from the bottom. A sill or landing extends along the interior of the longitudinal sidewalls. When the hood is closed, the elongated cooking trough 6 and steam hood 10 may form a hood seam that allows for the buildup of steam above the surface of oil within the elongated cooking trough, a process that blocks oxygen from reaching the oil and thereby prevents oil degradation via oxidation, a common problem with traditional kettle cookers. The steam hood 10 may be vented controllably by a steam stack 52. In certain embodiments, the steam hood 10 may be retractable or pivotable relative to the elongated cooking trough 6. The elongated cooking trough 6 and steam hood 10 are preferably made from stainless steel, for example, Stainless Steel 304 or 316.

An infeed may be provided at a proximal end of the elongated cooking trough 6. Feedstock, such as raw potato slices, may be introduced into heated cooking oil in the elongated cooking trough 6 via the infeed. The infeed may be slidable, rotatable, an infeed conveyor, high speed belt, vibratory equipment, or other type of infeed mechanism known to those of skill in the art. The infeed may also be interfaced with additional suitable equipment to provide high speed and automated input of feedstock into the dual purpose fryer 50.

Dual purpose fryer 50 may include removal conveyor at the distal end of the elongated cooking trough 6. At the end of a cooking cycle, the removal conveyor allows for cooked chips to be removed from the elongated cooking trough 6 for post-cooking processing, such as drying, flavoring, etc. The removal conveyor may preferably be a mesh or other porous configuration that allows for oil to drop from cooked chips as they travel on the conveyor. The conveyor and underlying structure may be inclined and configured to allow for shed oil from the cooked chips traveling on the conveyor to be directed to the cool oil outlet pipe 38.

The elongated cooking trough 6 may include a bed across the distal end of the trough. In certain embodiments, the bed may be connected to the cool oil system by providing fluid communication between the elongated cooking trough 6 and oil inlets and oil outlets.

As discussed briefly above, elongated cooking trough 6 may further include a plurality of cooking zones, each cooking zone including a cool oil fryer outlet 32 for the removal of cool cooking oil from the cooking zone, and a hot oil fryer inlet 34 for providing hot cooking oil to the elongated cooking trough 6 within the cooking zone. It will be appreciated that although the illustrated dual purpose fryer 50 includes five cooking zones, dual purpose fryers with fewer or greater numbers of cooking zones are anticipated.

During cooking, a conveyor 24 including a top belt 26 provides motive force from the infeed (proximal end) toward the distal end of the elongated cooking trough 6. Furthermore, conveyor 24 may be configured to agitate the cooking product as it traverses the elongated cooking trough 6.

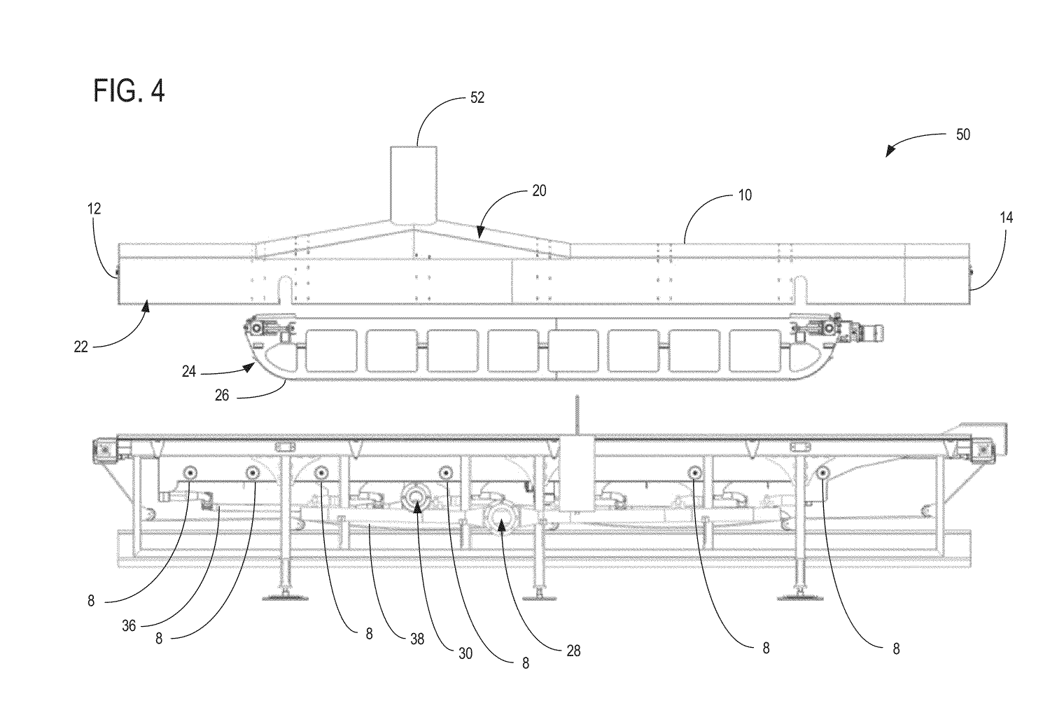

Turning now to FIG. 4, an exploded side view of dual purpose fryer 50 is provided. Conveyor 24 may be configured to be supported within elongated cooking trough 6 by steam hood 10. Additionally conveyor 24 and top belt 26 may be modularly configured such that an appropriate conveyor, belt, or other suitable attachment required by the desired cooking process may be installed into dual purpose fryer 50. Conveyor 24 may include one or more drive motors or any other suitable method to drive top belt 26.

Alternatively, dual purpose fryer 50 may be configured with a plurality of paddle assemblies at fixed locations along the longitudinal length of the elongated cooking trough 6. These paddle assemblies may be operated to provide motive force to and agitate cooking products as they traverse the longitudinal length of the elongated cooking trough 6.

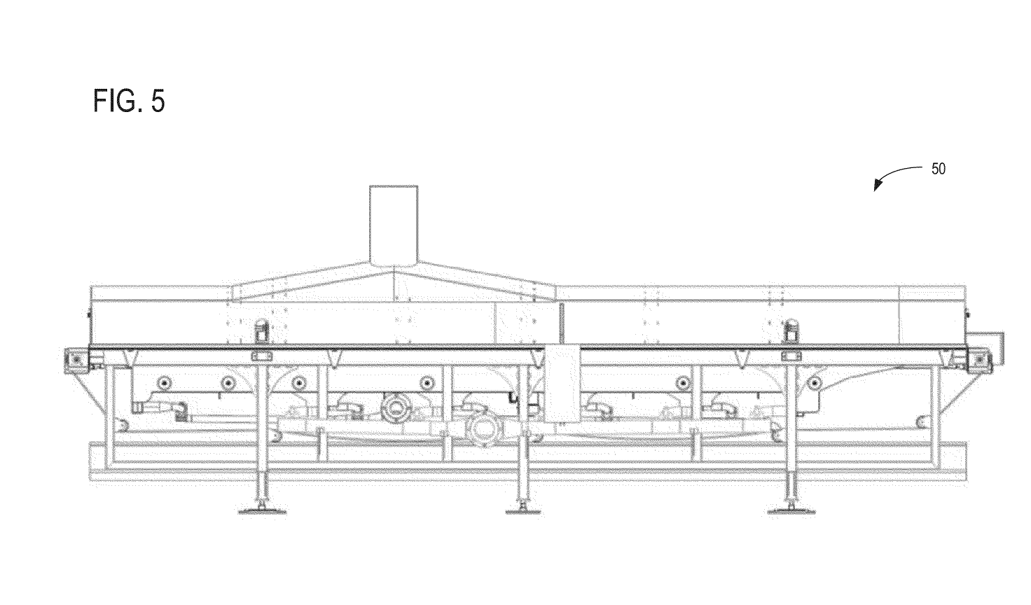

FIG. 5 illustrates a side view of dual purpose fryer 50 with the steam hood down. For the sake of brevity, like parts labelled in the preceding figures are not labelled and will not be discussed in additional detail.

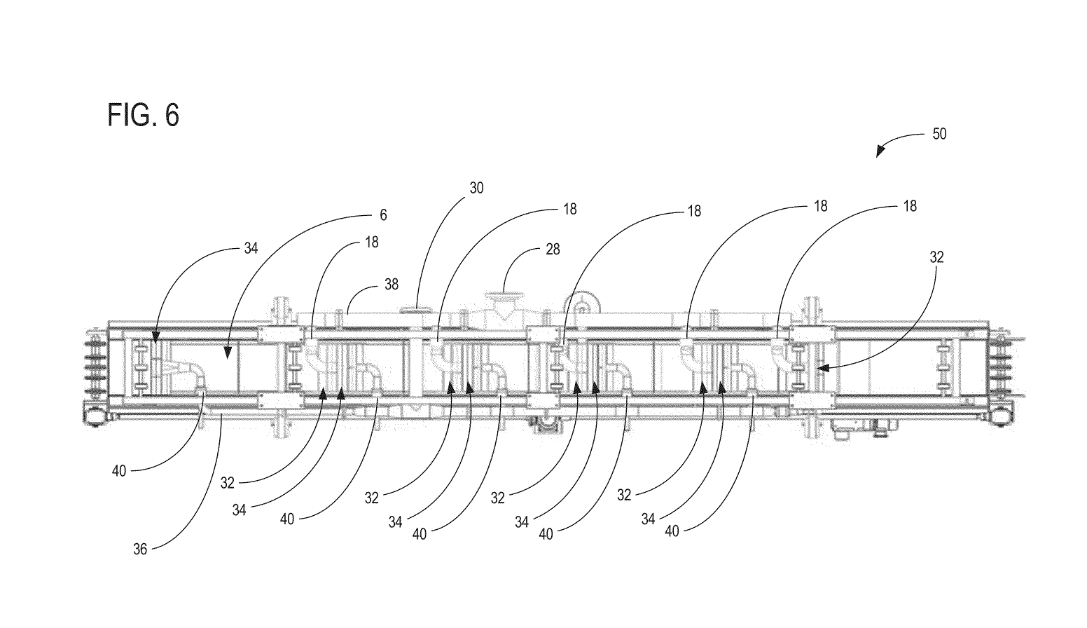

FIG. 6 provides a bottom view of dual purpose fryer 50. Dual purpose fryer 50 includes two distinct piping systems for the removal of cool cooking oil from elongated cooking trough 6 and the return of hot cooking oil to the elongated cooking trough 6. Each of the plurality of cool oil fryer outlets 32 are in fluid connection with a cool oil outlet flow control valve 18 controlling the flow of cool cooking oil from the elongated cooking trough 6 to a common cool oil outlet pipe 38. Cool oil outlet pipe 38 may include a cool oil outlet connection 28. Each of the plurality of hot oil fryer inlets 34 are in fluid connection with a hot oil outlet flow control valve 40 controlling the flow of hot cooking oil from a common hot oil inlet pipe 36 to the elongated cooking trough 6. Hot oil inlet pipe 36 may include a hot oil inlet connection 30 in fluid connection with a cooking oil heating system.

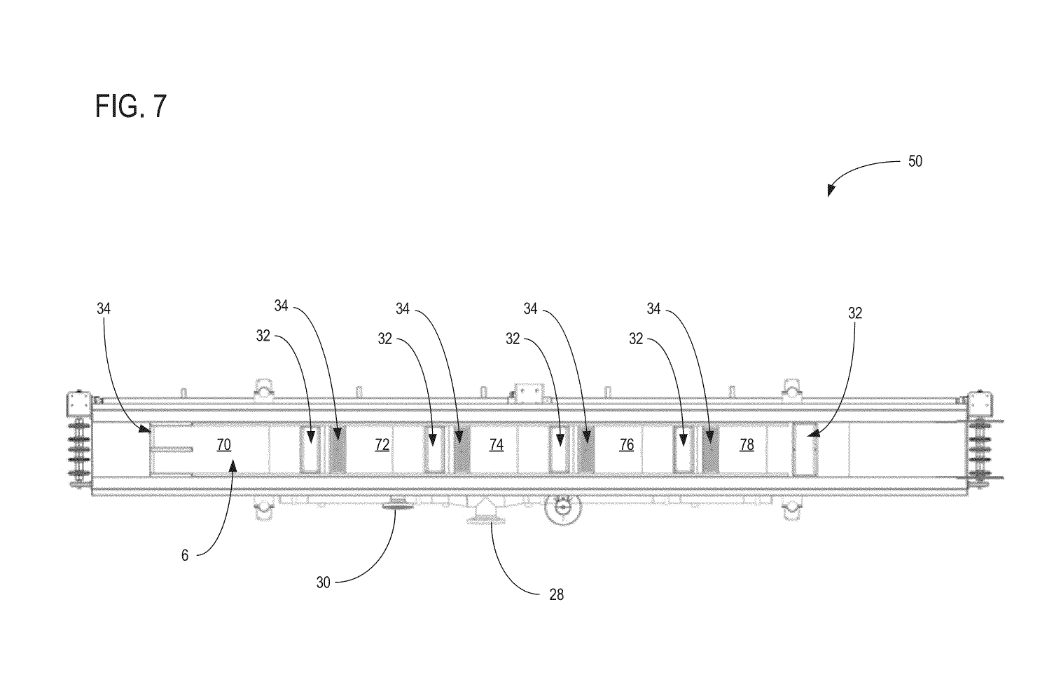

FIG. 7 is a top view of the elongated cooking trough 6 of the dual purpose fryer 50 illustrating a plurality of hot oil fryer inlets 34 including oil inlet top plates through which hot cooking oil is pumped. Also illustrated in FIG. 7 is a plurality of cool oil fryer outlets including oil outlet grates, which allow cool cooking oil to pass from the elongated cooking trough 6 to the cool oil fryer outlets. As illustrated in FIG. 7, the top plates of the hot oil fryer inlets 34 and outlet grates of the cool oil fryer outlets 32 extend laterally the width of the elongated cooking trough 6, although it will be appreciated that such a configuration is only a representative embodiment. The hot oil fryer inlets 34 and cool oil fryer outlets 32 need not be lateral, as illustrated, but can also be longitudinal, or any other position. The hot oil fryer inlets 34 and cool oil fryer outlets 32 need not be positioned in the bed of the elongated cooking trough 6, but may be positioned on the walls of the elongated cooking trough 6, or in other locations as long as they are able to perform the necessary functions to allow the dual purpose fryer 50 to operate.

An exemplary cool oil fryer outlet 32 may include an outlet grate allowing cooking oil to flow from the elongated cooking trough 6 into an outlet trough or outlet piping in fluid connection with cool oil outlet flow control valve 18. The outlet trough may be sloped in shape such that, when mounted to the elongated cooking trough 6, oil flowing into the outlet trough will then flow towards (e.g., driven by gravity) oil outlet flow control valve 18. The flow of oil through the cool oil fryer outlet 32 is controlled by the cool oil outlet flow control valve 18. Thus, the temperature of the cooking oil within a cooking zone may be controlled by changing the rate that cooking oil is removed from the cooking zone by changing the valve position of cool oil outlet flow control valve 18. It will be appreciated that a throttle valve for oil outlet flow control may be included either upstream or downstream of cool oil outlet flow control valve 18 to provide finer flow control of cool cooking oil from the cooking zone. It will be further appreciated that the position of cool oil outlet flow control valve 18 and any throttle valve for cool oil outlet flow control may be monitored or actuated remotely by a temperature control system or temperature control unit. Cool oil outlet flow control valve 18 may include a valve position sensor configured to provide a signal indicating the valve position of cool oil outlet control valve 18 to the temperature control system.

A baffle, in certain embodiments, may controllably open and close (e.g., rotatably opens and closes) to regulate the uniformity of cool oil passing through the width of the fryer. For example, the baffle may be mechanically controlled by an automated temperature control system. If the baffle is closed, in some examples, the oil flow may be restricted. If the baffle is open oil flow across the conveyor width may be controlled.

An exemplary hot oil fryer inlet 34 will now be discussed. Each hot oil fryer inlet 34 may include a plate having a plurality of holes suspended by brackets on an inlet trough of the hot oil fryer inlet. The plate functions to ensure that the heated cooking oil spreads across the full length of the inlet trough before entering the elongated cooking trough 6. The plate helps to homogenize the temperature of heated cooking oil entering the elongated cooking trough 6, so as to eliminate the potential for “hot spots”/“cold spots” along the width of the elongated cooking trough 6 within a respective cooking zone. In some examples, the plate may be canted at an angle similar to the inlet trough. The flow of hot cooking oil to each hot oil fryer inlet may be controlled by a hot oil inlet flow control valve 40. Thus, the temperature of the cooking oil within a cooking zone may be controlled by changing the rate that hot cooking oil is added to the cooking zone by changing the valve position of hot oil inlet flow control valve 40. It will be appreciated that a throttle valve for hot oil inlet flow control may be included either upstream or downstream of hot oil inlet flow control valve 40 to provide finer flow control of hot cooking oil to the cooking zone. It will be further appreciated that the position of hot oil inlet flow control valve 40 and any throttle valve for hot oil inlet flow control may be monitored or actuated remotely by a temperature control system. Hot oil inlet flow control valve 40 may include a valve position sensor configured to provide a valve position signal indicating the valve position of hot oil inlet flow control valve 40 to the temperature control system.

Referring specifically to FIG. 7, the flow of cooking oil will now be described in more detail. In the embodiment of the dual purpose fryer 50, the dual purpose fryer 50 includes five cooking zones, a first (proximal) cooking zone 70, a second (intermediate) cooking zone 72, a third (intermediate) cooking zone 74, a fourth (intermediate) cooking zone 76, and a fifth (distal) cooking zone 78. It will be appreciated that in alternative embodiments of dual purpose fryer, the number of cooking zones may vary. For example, some embodiments may include two or more cooking zones.

Each cooking zone may be defined by features allowing for temperature control of the zone so as to optimize the cooking process and to account for local variations in oil temperature during the cooking process. For example, the first cooking zone 70 extends from the most proximal hot oil fryer inlet 34 to the most proximal cool oil fryer outlet 32. The second cooking zone 72 extends from the second most proximal hot oil fryer inlet 34 to the second most proximal cool oil fryer outlet 32, etc. Further, the temperature control of each cooking zone may collectively establish a thermal profile similar to a batch cook process or a continuous cook process. For example, the temperatures of the first cooking zone, second cooking zone, third cooking zone, fourth cooking zone, and fifth cooking zone may be set such that as the chip moves from cooking zone to cooking zone, the chip is exposed to the inverted bell shaped thermal profile of the batch cook process.

Further, while the cooking trough may be divided into a plurality of cooking zones, there are no physical barriers between each cooking zone. In other words, the plurality of cooking zones are fluid connected with no impediment to flow of cooking oil between the cooking zones. The mechanisms associated with the temperature control of the oil within each cooking zone will now be explained in further detail.

The second cooking zone 72 will now be described in more detail, although it will be appreciated that in the dual purpose fryer 50 illustrated in FIG. 7, the first, second, third, fourth, and fifth cooking zones 70, 72, 74, 76, and 78, respectively, have similar features and, therefore, the description of the second cooking zone 72 applies equally to the other cooking zones.

The second cooking zone 72 includes a hot oil fryer inlet 34 in fluid communication with the hot oil inlet flow control valve and hot oil inlet pipe. The hot oil inlet flow control valve controls the amount of oil, if any, passing from the hot oil inlet pipe into a hot oil fryer inlet 34. The hot oil fryer inlet 34 is sized and configured to provide heated oil to the elongated cooking trough 6 within the second cooking zone 72. The hot oil fryer inlet 34 is configured to integrate into the elongated cooking trough 6 such that a top plate of the hot oil fryer inlet 34 is coplanar with the bed of the elongated cooking trough 6 (e.g., the top plate is welded into the bed). The top plate may include a plurality of pipes providing fluid communication between an oil inlet trough of the hot oil fryer inlet 34 and the elongated cooking trough 6. During operation of the dual purpose fryer 50, hot oil flows from the cooking oil heating system (not shown) through the hot oil inlet connection 30 through the hot oil inlet pipe through the hot oil inlet flow control valve, through an opening in the inlet trough, and through the pipes into the second cooking zone of the elongated cooking trough 6. The inlet trough is symmetrically canted such that the opening is at the lowest point of the inlet trough such that oil flowing into the inlet trough is laterally distributed evenly. The flow rate of hot cooking oil through the hot oil fryer inlet 34 into the elongated cooking trough is controlled by the hot oil inlet flow control valve. Alternatively (or additionally), the hot oil flow may be controlled by additional valves (or other control mechanisms). For example, each of the pipes may be controlled individually by a valve (not illustrated) to further improve local temperature control of cooking oil in the elongated cooking trough 6.

Simultaneously, cool cooking oil may be removed from the second cooking zone through the cool oil fryer outlet 32. Cool cooking oil may flow from elongated cooking trough 6 through the cool oil fryer outlet 32 through the cool oil outlet flow control valve through a cool oil outlet pipe and return to the cooking oil heating system through cool oil outlet connection 28. The rate of flow of cool cooking oil through the cool oil fryer outlet 32 may be controlled by the cool oil outlet flow control valve and/or additional valves (or other control mechanisms). Thus the temperature of the cooking oil within the second cooking zone 72 is maintained through the precise control of the rate of hot oil addition and the rate of cool oil removal from the elongated cooking trough 6 within the second cooking zone 72.

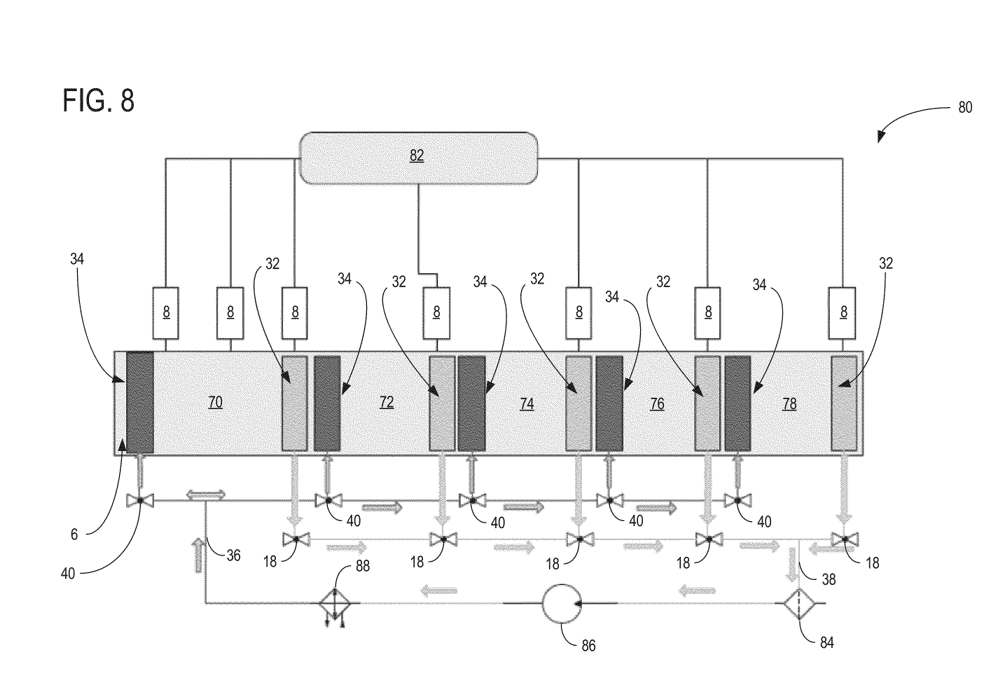

FIG. 8 schematically illustrates a system for controlling the temperature of cooking oil for the dual purpose fryer in accordance with an embodiment of the present disclosure. Temperature control system 80 may include a temperature control panel 82. Temperature control panel 82 may receive signals from the plurality of thermal sensors 8 indicating the temperature of the cooking oil adjacent the thermal sensor 8 within each of the cooking zones of the dual purpose fryer, signals indicating valve positions of the flow control valves within temperature control system 80, and signals indicating system pressures at various points within temperature system (e.g. at the inlet and the outlet of cooking oil filter 84, cooking oil pump 86, and/or heat exchanger 88). Temperature control panel 82 may provide a readout of the temperature indicated by each thermal sensor 8. Additionally, temperature control panel 82 may provide indications of additional parameters of the temperature control system 80 such as valve position indication for each of the cool oil outlet flow control valves 18 and hot oil inlet flow control valves 40, indication of the flow rate of cool cooking oil through each cool oil outlet flow control valve 18, indication of flow rate of hot cooking oil through each hot oil inlet flow control valve 40, indication of the operational parameters of cooking oil filter 84, cooking oil pump 86, and heat exchanger 88, and/or indication of any other suitable operational parameter of the dual purpose fryer, for example. Temperature control panel 82 may enable remote actuation of the dual purpose fryer including flow control valves, cooking oil pump 86, the conveyor, and/or any other component of the dual purpose fryer.

In some embodiments, temperature control panel 82 may include an automated temperature control unit in addition to the indications described above. In these embodiments, the temperature control unit may automatically control the temperature of the cooking oil within each respective cooking zone as described above.

During operation, cooking oil is pumped through the dual purpose fryer and temperature control system 80 by cooking oil pump 86. The flow of cooking oil through temperature control system 80 is indicated by directional arrows in FIG. 8 and will now be discussed. Beginning at the dual purpose fryer, cool cooking oil is removed from each cooking zone (70, 72, 74, 76, and 78) of the elongated cooking trough 6 via cool oil fryer outlets 32. The flow rate of the cool cooking oil through each cool oil fryer outlet 32 may be a function of the position of cool oil outlet flow control valve 18 and the flow capacity of cooking oil pump 86. Cool cooking oil from each cooking zone then flows to the common cool oil outlet pipe 38 through a cooking oil filter 84 to the inlet of cooking oil pump 86. Cooking oil pump 86 pumps the cooking oil to heat exchanger 88 where the cooking oil is heated to a set temperature. From the heat exchanger, the cooking oil flows through the common hot oil inlet pipe 36. The hot cooking oil may then flow to each cooking zone through a respective hot oil inlet flow control valve 40 and hot oil fryer inlet 34. The flow rate of hot cooking oil through each hot oil fryer inlet 34 is controlled by the position of the hot oil inlet flow control valve 40. As discussed above, the temperature of the cooking oil within each respective cooking zone is a function of the flow rate of cool oil removed from the cooking zone and the flow rate of the hot oil added to the cooking zone.

The dual purpose fryer and related method provided herein are described in relation to cooking potato chips. However, it will be appreciated that the disclosure is not limited only to the cooking of potato chips made from potatoes, but can be used on any suitable feedstock. For example, alternatives to chips made from potatoes include chips made from vegetables such as yams, sweet potatoes, and the like.

An exemplary dual fryer for production of different types of potato chips, with varying thermal profiles will now be described.

In this first example, raw potato slices may be continuously added at the infeed (proximal end) of the elongated cooking trough 6 of heated cooking oil. The plurality of cooking zones within the elongated trough may be configured such the rate of cool oil removal and the rate of addition of hot cooking oil produces a thermal profile for a batch cook process as illustrated in FIG. 9B. It will be understood that the rate of oil removal will be a function of the position of the cool oil outlet flow control valve 18 associated with each respective cooking zone. It will also be understood that the rate of hot oil addition will be a function of the position of the hot oil inlet flow control valve 40 associated with each respective cooking zone. Further, the temperature of the hot oil provided to the dual purpose fryer 50 may be adjusted to establish the desired thermal profile. Other factors that may be adjusted to establish the batch cook process thermal profile include the rate of addition of the raw potato slices at the infeed and the rate at which the conveyor 24 moves the chips through the hot cooking oil within the elongated cooking trough 6. The conveyor 24 rotates the belt forward along the longitudinal length of the elongated cooking trough 6 which has the effect of pushing the chips through each of the five cooking zones to the removal end of the elongated cooking trough 6. At the distal end of the elongated cooking trough 6 a removal conveyor may be positioned above the most distal cool oil fryer outlet 32 and the cooking oil flows through the mesh of the removal conveyor such that the cooked chips are deposited on the removal conveyor and moved away from the elongated cooking trough 6. Upon completion of a cook, all of the cooking oil may be drained from the elongated cooking trough 6 for cleaning and reheating prior to use in a subsequent cook.

Further, dual purpose fryer 50 may enable the operator to reconfigure the hot oil inlet flow control valves, cool oil outlet flow valves, and the conveyor to establish the continuous cook process thermal profile of FIG. 9B. The dual purpose fryer 50 may then perform a continuous cook process of typical potato chips, for example. It will be appreciated that in addition to the valve manipulations required to establish the desired thermal profile, the operator may configure the conveyor according to the requirements of the desired cook process and/or the product to be cooked.

The methods discussed above may be applied individually or in combination to maintain the oil temperature and/or thermal profile within a desired band or profile. The flow of oil through each of the hot oil fryer inlets and cool oil fryer outlets may be controlled through valve manipulations performed manually by an operator prior to and during operation as required. Alternatively, a control system may monitor the temperature of each cooking zone and automatically adjust cooking oil flow. It will be appreciated that as each cooking zone is in direct fluid communication that the adjustments to each respective temperature zone may be coordinated to maintain the desired thermal profile across the elongated cooking trough.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A dual purpose fryer for continuous preparation of a fried product, comprising:
an elongated cooking trough configured to hold a volume of cooking oil and including a plurality of fluid connected cooking zones;
wherein a cooking oil temperature within each of the cooking zones is established by controlling a flow rate of hot cooking oil into the cooking zone through a hot oil fryer inlet and a flow rate of cool cooking oil from the cooking zone through a cool oil outlet; and
wherein the cooking oil temperature within each of the cooking zones collectively establishes a thermal profile corresponding to a cook process.

2. The dual purpose fryer of claim 1, wherein the cooking oil temperature within each of the cooking zones establishes a thermal profile corresponding to a continuous cook process.

3. The dual purpose fryer of claim 1, wherein the cooking oil temperature within each of the cooking zones establishes a thermal profile corresponding to a batch cook process.

4. The dual purpose fryer of claim 1, wherein each of the fluid connected cooking zones includes:
a thermal sensor configured to provide an indication of the temperature of the cooking oil within a respective cooking zone;
a hot oil fryer inlet configured to supply hot cooking oil to the respective cooking zone within the elongated cooking trough;
a hot oil inlet flow control valve in fluid connection with the hot oil fryer inlet configured to control a flow rate of hot cooking oil to the hot oil fryer inlet;
a cool oil fryer outlet configured to remove cool cooking oil from the respective cooking zone within the elongated cooking trough; and
a cool oil outlet flow control valve in fluid connection with the cool oil fryer outlet configured to control a flow rate of cool cooking oil through the cool oil fryer outlet.

5. The dual purpose fryer of claim 4, further comprising a control unit configured to automatically adjust a thermal profile of the cooking oil in the elongated cooking trough, the control unit configured to, for each of the plurality of cooking zones:
receive a temperature input signal indicating the temperature of the cooking oil adjacent the thermal sensor;
receive a valve position signal of the hot oil inlet flow control valve or the cool oil outlet flow, where the valve position signal of the hot oil inlet flow control valve indicates a flow rate of hot cooking oil through the hot oil inlet control valve or the cool cooking oil through the cool oil inlet control valve, respectively; and
change a position of the hot oil inlet flow control valve to control a flow rate of hot cooking oil entering the cooking zone or change a position of the cool oil inlet flow control valve to control a flow rate of cool cooking oil entering the cooking zone, respectively.

6. The dual purpose fryer of claim 1, further comprising a plurality of paddles disposed in the elongated cooking trough.

7. The dual purpose fryer of claim 1, further comprising a conveyor configured to convey a product through each of the plurality of cooking zones, wherein the rate of conveyance of the conveyor is adjustable.

8. The dual purpose fryer of claim 1, wherein the elongated cooking trough includes at least two cooking zones.

9. The dual purpose fryer of claim 1, further comprising a product infeed positioned at a proximal end of the elongated cooking trough configured to continuously provide uncooked product to the elongated cooking trough and a removal conveyor positioned at the distal end of the elongated cooking trough configured to continuously remove cooked product from the elongated cooking trough.

10. The dual purpose fryer of claim 7, wherein the conveyor is interchangeable.

11. The dual purpose fryer of claim 1, further comprising a heat exchanger configured to receive cool cooking oil from the dual purpose fryer through the cool oil fryer outlet and return hot cooking oil to the dual purpose fryer via the hot oil fryer inlet.

12. A dual purpose fryer, comprising:
an elongated cooking trough configured to hold a volume of cooking oil, wherein the elongated cooking trough includes a plurality of fluid connected cooking zones, each of the plurality of cooking zones including:
a thermal sensor configured to provide an indication of the temperature of the cooking oil within a respective cooking zone;
a hot oil fryer inlet configured to supply hot cooking oil to the respective cooking zone within the elongated cooking trough;
a hot oil inlet flow control valve in fluid connection with the hot oil fryer inlet configured to control a flow rate of hot cooking oil to the hot oil fryer inlet;
a cool oil fryer outlet configured to remove cool cooking oil from the respective cooking zone within the elongated cooking trough;
a cool oil outlet flow control valve in fluid connection with the cool oil fryer outlet configured to control a flow rate of cool cooking oil through the cool oil fryer outlet;
wherein the temperature of the cooking oil within the respective cooking zone is a function of the flow rate of hot cooking oil to the hot oil fryer inlet and the flow rate of cool cooking oil through the cool oil fryer outlet;
a conveyor configured to convey a product through each of the plurality of cooking zones, wherein the rate of conveyance of the conveyor is adjustable;
a product infeed positioned at a proximal end of the elongated cooking trough configured to continuously provide uncooked product to the elongated cooking trough;
a removal conveyor positioned at the distal end of the elongated cooking trough configured to continuously remove cooked product from the elongated cooking trough; and
wherein the temperature of the cooking oil within each of the plurality of cooking zones, the rate of conveyance of the conveyor, a rate of introduction of uncooked product to the elongated cooking trough, and a rate of removal of cooked product from the elongated cooking trough are configured to obtain a first inverted bell curve thermal profile associated with a batch cook process across a longitudinal length of the elongated cooking trough.

13. The dual purpose fryer of claim 12, wherein the temperature of the cooking oil within each of the plurality of cooking zones, the rate of conveyance of the conveyor, a rate of introduction of uncooked product to the elongated cooking trough, and a rate of removal of cooked product from the elongated cooking trough are configured to obtain a second saw tooth curve thermal profile associated with a continuous cook process across the longitudinal length of the elongated cooking trough.

14. The dual purpose fryer of claim 12, wherein the elongated cooking trough includes at least two cooking zones.

15. The dual purpose fryer of claim 12, wherein the conveyor is interchangeable.

16. The dual purpose fryer of claim 12, further comprising a control unit configured to automatically adjust a thermal profile of the cooking oil in the elongated cooking trough, the control unit configured to, for each of the plurality of cooking zones:
receive a temperature input signal indicating the temperature of the cooking oil adjacent the thermal sensor;
receive a valve position signal of the hot oil inlet flow control valve, where the valve position signal of the hot oil inlet flow control valve indicates a flow rate of hot cooking oil through the hot oil inlet control valve; and
change a position of the hot oil inlet flow control valve to control a flow rate of hot cooking oil entering the cooking zone.

17. The dual purpose fryer of claim 16, wherein the control unit is further configured to, for each of the plurality of cooking zones:
receive a temperature input signal indicating the temperature of the cooking oil adjacent the thermal sensor;
receive a valve position signal of the cool oil outlet flow control valve, where the valve position signal of the cool oil outlet flow control valve indicates a flow rate of cool oil through the cool oil outlet control valve; and
change a position of the cool oil outlet flow control valve control to control a flow rate of cool cooking oil removed from the cooking zone.

18. A method of operating a dual purpose fryer, the method comprising:
establishing a thermal profile across an elongated cooking trough containing a volume of cooking oil and including a plurality of fluid connect cooking zones, wherein establishing the thermal profile includes establishing a cooking oil temperature within each of the plurality of cooking zones includes:
receiving an indication of a temperature of cooking oil within the cooking zone from a thermal sensor;
adjusting a flow rate of hot cooking oil to the cooking zone through a hot oil fryer inlet; and
adjusting a flow rate of cool cooking oil from the cooking zone through a cool oil fryer outlet;
adjusting a rate of introduction of uncooked product to the volume of cooking oil at a proximal end of the elongated cooking trough;
adjusting a rate of conveyance of a conveyor configured to convey the product through each of the plurality of cooking zones; and
adjusting a rate of removal of cooked product from the elongated cooking trough at a distal end of the elongated cooking trough.

19. The method of claim 18, wherein the thermal profile corresponds to a batch cook process.

20. The method of claim 18, wherein the thermal profile corresponds to a continuous cook process.
